(19) United States
(12) Patent Application Publication
(10) Pub. No.: US 2008/0164288 A1
(43) Pub. Date: Jul. 10, 2008

(54) Package for Dispensing a Flowable Particulate Material

(75) Inventor: Lisa Singleton, Greensboro, NC (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: N.S. Packaging LLC

(21) Appl. No.: 11/620,874

(22) Filed: Jan. 8, 2007

(51) Int. Cl. B05C 19/04; A01C 15/02; A01C 7/02; B65D 83/06

(52) U.S. Cl. 222/465.1; 239/652; 222/105; 222/107; 222/565

(57) ABSTRACT

The dispensing package of the present invention provides a package that can be loaded with a flowable particulate material and sealed to provide a package for storage, shipment, and distribution of the of the particulate material. The dispensing package has a series of internal seals that are spaced apart from each other to define distribution flow channels through which the particulate material can be controllably dispensed from within the package. The dispensing package can be reclosed and resealed by the consumer after opening to allow for storage of the remaining particulate material until needed. A dispensing package can be used to dispense and distribute a wide variety of materials. For example, it is particularly useful for dispensing particulate materials having a relatively small average cross section such as pellets, grains, powders, seeds, plant nutrient, insect dust, and chalk.

### FIELD OF THE INVENTION

The present invention relates to a dispenser package, and more particularly to a recloseable pouch-like package having a series of interior distribution channels for dispensing a flowable particulate matter.

### BACKGROUND OF THE INVENTION

It is common to spread flowable particulate materials, such as powders, seeds, pellets, and the like, over a surface using mechanical spreading equipment that distributes the particulate material from a hopper. In general, such equipment can be rather bulky and cumbersome to use and operate. Additionally, such equipment is generally only used when it is desirable to spread the particulate material over a relatively large surface area.

In some cases, the mechanical equipment may have only limited access or maneuverability in the area over which the particulate material is to be spread. In such cases, it may be necessary to spread the particulate matter using hand spreading or spreading with a hand-held scoop. This type of spreading can result in uneven spreading over the target surface. It can also result in spillage of the particulate material. Accordingly, there exists a need for alternatives means for spreading particulate materials.

### BRIEF SUMMARY OF THE INVENTION

The dispensing package of the present invention provides a package that can be loaded with a flowable particulate material and sealed to provide a package for storage, shipment, and distribution of the of the particulate material. The dispensing package has a series of internal seals that are spaced apart from each other to define distribution flow channels through which the particulate material can be controllably dispensed from within the package. The dispensing package can be reclosed and resealed by the consumer after opening to allow for storage of the remaining particulate material until needed. A wide variety of products can be dispensed from the package. For example, it is particularly useful for dispensing particulate materials having a relatively small average cross section such as pellets, grains, powders, seeds, plant nutrient, insect dust, and chalk.

The dispensing package of the present invention includes opposed flexible first and second sheets, each having a top edge, a bottom edge, and opposed side edges extending longitudinally from the top edge to the bottom edge. Side seams extend longitudinally along the opposed side edges to join the front and back walls to one another. When in a closed state, the dispensing package includes a closure and an opposite bottom closure that both extend transversely across the width of the package from one side edge to the opposite side edge to define a closed package having an interior space therebetween. Collectively, the bottom closure, top closure, and opposite side seams define a sealed package having an interior space for containing a flowable particulate matter therein.

The dispensing package can be formed by forming the side seams and bottom closure to produce a package having an interior space wherein the top edges of the first and second sheets are unconnected to thereby define an opening into the interior space of the package. The package can then be at least partially filled by introducing a flowable particulate matter into the interior of the package through the opening. After filling, the top end of the package can be sealed with a top seam that extends laterally across the width of the package from one side edge to an opposite side edge.

In one advantageous embodiment, a series of interior seals are located between the first and second sheets and extend from one side edge to the opposite side edge. The series of interior seals join the inner surfaces of the first and second sheets to one another in discrete areas that are spaced apart from one another. The interior seals are located in the interior of the package between the top edge and the bottom closure, and preferably are adjacent to the bottom closure. The interior seals define unsealed regions of the inner surfaces of the first and second sheets that are located between the adjacent spaced apart interior seals. These unsealed regions define distribution channels through which particulate material may flow from the interior of the package in the direction of the bottom closure.

The interior seals are configured and arranged to control the flow rate at which the particulate material may exit the package. In one embodiment, the spacing between adjacent interior seals is at least 10 times the width dimension of the seals, and in particular at least 15 times the width dimensions of the seals. In some embodiments, the interior seals are spaced apart from one another by a distance of from about 1 cm to 8 cm, and preferably by a distance of from about 4 cm to 6 cm.

In one embodiment, as initially manufactured, the front and back walls are unsealed along the top edge to allow for filling of the dispensing package by a manufacturer through the open top end of the package.

In some embodiments, a portion of the bottom closure of the package may include a bottom seam that extends transversely from one side edge to the opposite side edge. The bottom seam can be opened by tearing or cutting along a portion of the bottom end of the dispensing package to thereby provide access to the resealable closure. The package may include notch, tab, line of weakening, or cutting designation that helps facilitate tearing of the package.

In one embodiment, a transversely extending resealable closure is spaced inwardly from the bottom closure of the first and second sheets and joins the first and second sheets to one another to form a resealable opening for the dispensing package. After the bottom seam has been removed, the dispsensing package may be selectively opened along resealable closure. Thereafter, distribution of the particulate material may be achieved by grasping the dispensing package and shaking, which causes flowable particulate material within package to be dispensed through the distribution channels. The flowable particulate material flows through the distribution channels and is distributed out of the now open bottom closure. A user can readily control distribution, by simply orienting the dispensing package above an object or area over which distribution of the particulate material is desired, and shaking the package appropriately.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a perspective of a dispensing package in which the particulate material is shown in the process of being dispensed;

FIG. 2 is a perspective view of a dispensing package in which the top end of the package is opened for receiving a particulate material therein;

FIG. 3 is a is an illustration of the dispensing package wherein a portion of the first sheet has been broken away to better illustrate the distribution channels;

FIG. 4 is an illustration of a dispensing package in the process of being filled with a particulate material;

FIG. 5 is an illustration of a dispensing package in the process of having a portion of the bottom end of the dispensing packaged removed to create an opening through which particulate material may be distributed; and

FIG. 6 is a graphical illustration of the dispensing package of FIG. 5 in the process of dispensing and distributing a particulate material.

### DETAILED DESCRIPTION OF THE INVENTION

The present invention now will be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout.

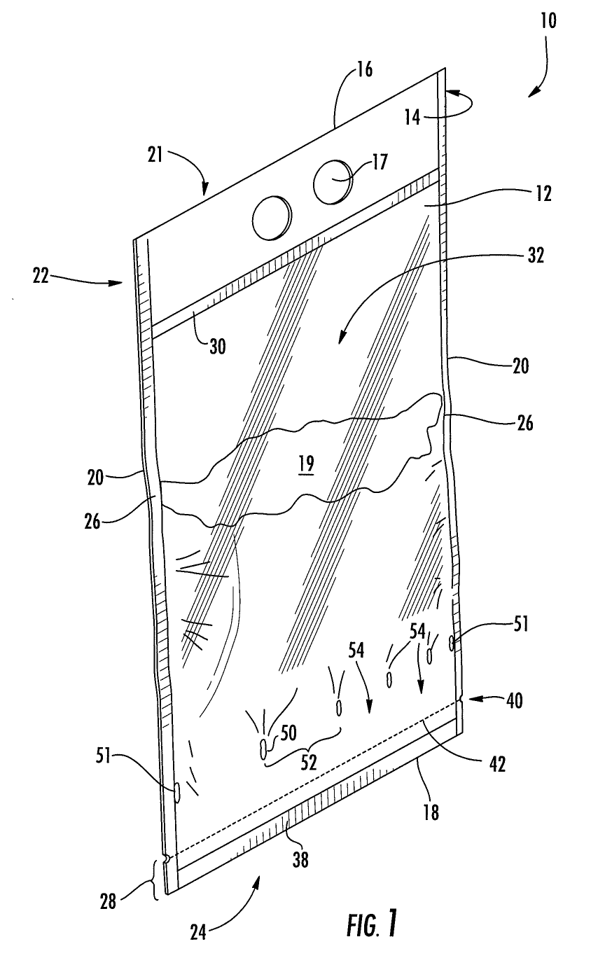

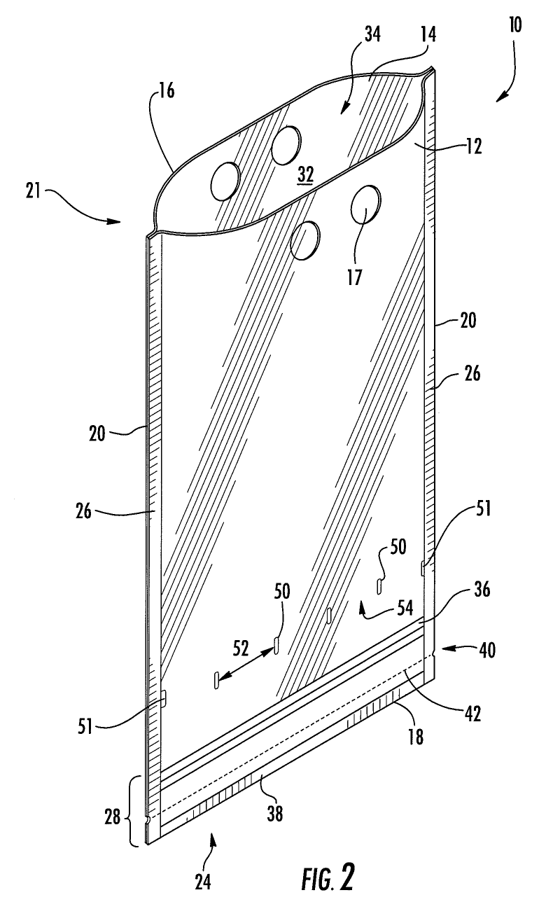

A dispensing package in accordance with one embodiment of the present invention as indicated generally in the drawing figures by the reference character 10. As best seen in FIGS. 1 and 2, the dispensing package includes first and second sheets 12, 14 formed of a flexible material that are arranged in opposing face-to-face relationship with one another. In the illustrated embodiment, the first and second sheets 12, 14 are of a generally rectangular shape, each having a top edge 16, a bottom edge 18 and opposite side edges 20 that extend longitudinally from the top edge 16 to the bottom edge 18. The embodiment illustrated in FIG. 1 has a top end 21 and an opposite bottom end 24. In the context of the invention, the term “package” is used in a generic sense and should be recognized to include bags, sacks, pouches, satchels and the like.

The first and second sheets 12,14 are joined to one another along the opposed side edges 20 by side seams 26. The side seams 26, as well as the other seams of the dispensing package to be described presently, can be formed by any of various methods conventionally used in the packaging industry, including seams formed mechanically, such as by sewing or stapling, adhesively, or by fusion, such as by forming seals by with heat or ultrasonic energy. In the particular embodiment illustrated, the first and second sheets are made from a heat sealable material and the side seams 26 are formed by producing a fusion bond or seal between contacting interior surfaces of the first and second sheet using pressure and heat or ultrasonic energy as is well known. Although referred to herein as “heat seals”, it should be understood that this term is intended to apply both to seals formed by heating the contacting surfaces with a heated anvil or platen, as well as to heating and fusion produced by other methods, such as application of ultrasonic energy.

The dispensing package 10 also includes a bottom closure 28 that extends transversely from one side edge to the opposite side edge to define a closed bottom for the dispensing package. In one embodiment, the bottom closure is adjacent to the bottom edge 18 of the first and second sheets 12, 14. As best seen in FIG. 1, the dispensing package 10 includes a top seam 30 that extends transversely from one side edge to the opposite side edge to define a top closure 22 of the dispensing package. Collectively, the bottom closure 28, top closure 22, and opposite side seams 26 define a sealed package having an interior space 32 for containing a flowable particulate matter therein.

Located interiorly of the package adjacent the bottom closure 28 is a series of interior seals, indicated collectively by the reference character 50. The series of interior seals join the inner surfaces of the first and second sheets to one another in discrete areas that are spaced apart from one another. Generally, the interior seals are located in the interior of the package between the top edge and the bottom closure, and preferably adjacent to the bottom closure. The interior seals define unsealed regions 52 of the inner surfaces of the first and second sheets that are located between the adjacent spaced apart interior seals. These unsealed regions 52 define distribution channels 54 through which particulate material may flow from the interior of the package in the direction of the bottom closure. In some embodiments, the interior seals may include opposite seals 51 that are positioned in the interior of the dispensing package adjacent to side seams 26.

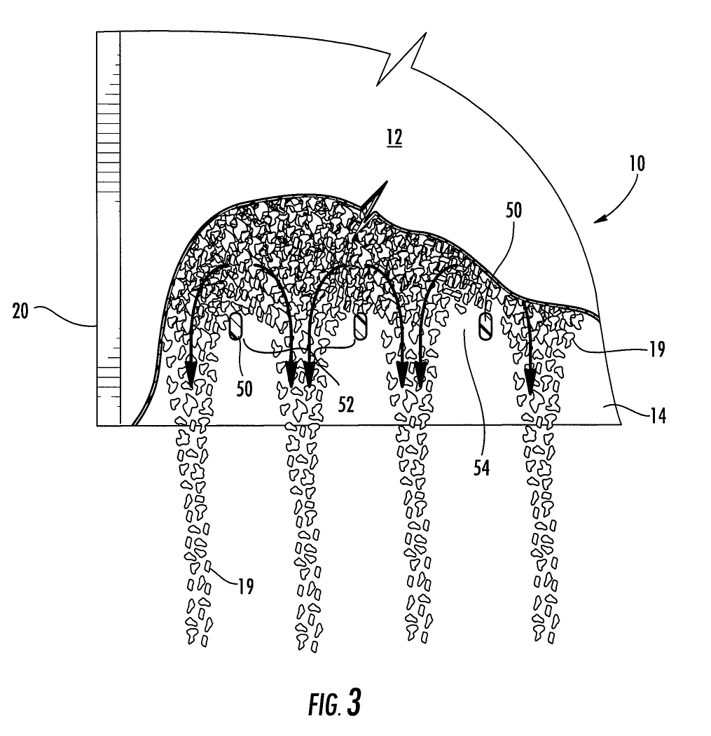

FIG. 3 is an illustration of the dispensing package 10 in which a portion of the front sheet 12 has been removed to help facilitate visualization of the particulate material 19 flowing through the distribution channels 54 from the interior of the package. The interior seals 50 are positioned and arranged to retard the flow of the particulate material through the distribution channels.

The interior seals are configured and arranged to control the flow rate at which the particulate material may exit the package. For example, the spacing, number, and distribution of the interior seals can be selected so that the particulate material flows through the distribution channels, and hence exits the package, at a desired distribution rate. In one embodiment, the spacing between adjacent interior seals is at least 10 times the width dimension of the seals, and in particular at least 15 times the width dimensions of the seals. In some embodiments, the interior seals are spaced apart from one another by a distance of from about 1 cm to 8 cm, and preferably by a distance of from about 2 cm to 6 cm. In one particular embodiment, the interior seals are spaced apart from one another by a distance of from about 4 cm to 6 cm.

Generally, the spacing between adjacent interior seals can be selected so that the particulate material flows through the distribution channel at a desired flow rates. The desired flow rate is dependent on the type, nature, and surface on which the particulate material is to be distributed over. In general, the flow rate can be selected by selecting the spacing between the interior seals based on the average particle size of the particulate material to be distributed. In one embodiment the spacing between adjacent interior seals is from about 2 to 3 times the average particle size of the particulate material, and in particular from about 3 to 5 times the average particle size of the particulate material being dispensed. For example, in one embodiment the flowable particulate material comprises grass seed having an average particle size from about 1 mm to 2 mm, and the spacing between adjacent interior seals is from about 25 to 75 times the average particle size of the grass seed.

Referring back to FIGS. 1 and 2, the dispensing package 10 can be formed by forming the side seams 26 and bottom closure 28 to produce a package having an interior space 32 wherein the top edge 16 of the first and second sheets 12, 14 is substantially unattached to thereby define an opening 34 into the interior of the package. The dispensing package can be filled by introducing a flowable particulate matter into the interior 32 of the package through opening 34, followed by forming a top seam 30 between the first and second sheets to thereby close opening 34. In one embodiment, top seam 30 is positioned in an area near the top edge of the first and second sheets. Top seam 30 can be formed as discussed above.

In one embodiment, the bottom closure 28, may take the form of a seal or seam 38 joining the first and second sheets to one another along or adjacent to the bottom edges of the sheets. The package may be opened to dispense its contents by cutting or tearing to remove the bottom portion of the package where the bottom seal or seam is located. In some embodiments, the bottom closure 28 may include a resealable closure 36 that extends transversely from one side edge to the opposite side edge. The resealable closure can be any of various known configurations that allow for opening and reclosing of the package. In the illustrated embodiment, the resealable closure comprises a pair of cooperating interlocking strips that are configured to releasably interconnect and to form a “press and seal” or zipper-type releasable interconnection. This type of resealable closure typically includes a rib-like male profile strip and a cooperating groove-like female profile that receives the rib-like male profile to form a seal. The closure can be closed simply by applying pressure along the length of the strips, or in some embodiments a zipper-type slider can be provided to facilitate opening and closing. These two strips are bonded to the interior surfaces of the first and second sheets 12, 14 in a suitable manner, preferably by heat sealing.

As shown in FIG. 2, the package can also include a bottom seam 38 that extends transversely from one side edge to an opposite side edge. The bottom seam 38 seals the package and prevents access to the resealable closure 36 until the dispensing package has been opened by the consumer. In this embodiment, the bottom seam is generally adjacent to the bottom edge of the first and second sheets 12, 14. The dispensing package may include a perforation, notch 40 or other line of weakening that may be conveniently provided adjacent to the bottom seam 38 to make it easier for the consumer to open the package by removing the bottom seam 38 to thereby gain access to the resealable closure 32. In one embodiment, the perforation, notch 40 or other line of weakening may be formed in a portion of the package between the resealable closure and the bottom seam. In some embodiments, the dispensing package may include a line of weakening 42 that can be used in combination with notch 40 to help facilitate easy opening of the bottom closure.

As discussed above, the location of the interior seals is typically near the bottom closure of the dispensing package. However, it should be recognized that the exact positions of the interior seals can be varied. In one embodiment, the interior seals may extend between the opposite side ends of the pouch in a substantially linear or straight path. Alternatively, the seals can extend in a substantially non-linear path, such as in a zig-zag path, semi-circular path, or a random path.

The shape and orientation of the interior seals can also be selected to help control the flow rate at which the particulate material exits the package. In FIGS. 2 and 3, the interior seals are depicted as having a rectangular or oblong shape wherein the length of the interior seal extends generally in the direction of the bottom closure. In embodiments where the interior seals have a rectangular or oblong shape, the interior seals may have a width that is between about 0.15 cm to 0.75 cm, and in particular between about 0.3 cm and 0.65 cm, and a length between about 0.75 cm to 1.25 cm, and in particular between about 0.85 cm and 1 cm.

In other embodiments, the interior seals may have a triangle-like shape, square-like shape, V-like shape, diamond-like shape, and combinations thereof. In a particularly useful embodiment, the interior seals have an inverted triangle or V-like shape that helps to funnel the particulate material in the direction of the distribution channels.

In some embodiments, the dispensing package 10 may also include a handle that helps facilitate carrying and use of the dispensing package. In the illustrated embodiments, the top end of the dispensing package includes an upper flap region having one or more handle apertures 17 that are formed in the first and second sheet above the top seam. Handle apertures help facilitate the moving and shaking of the dispensing package.

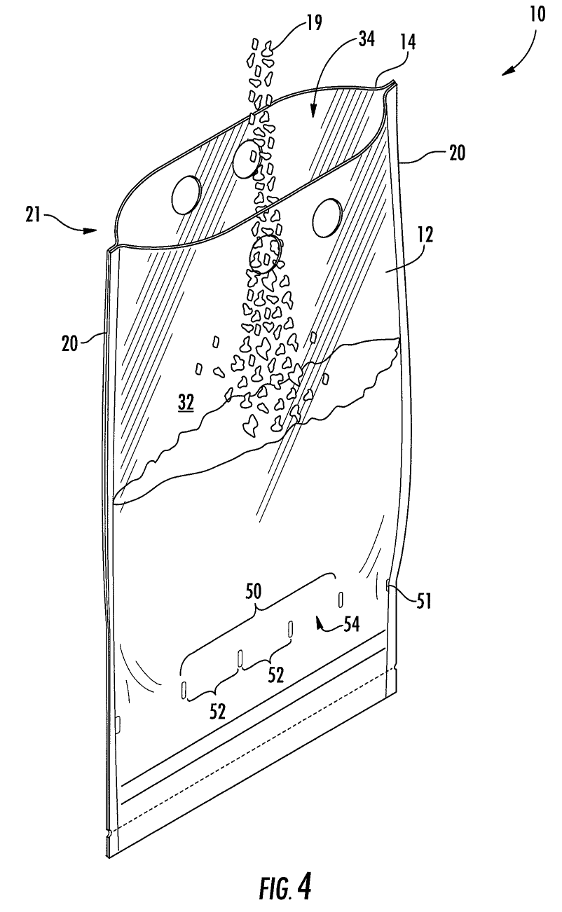

With reference to FIG. 4, a dispensing package 10 is depicted in the process of being filled with a particulate material 19. Once filled the top end 21 of the package is closed by forming a transverse seal between the first and second sheets and that extends from one side seam to the opposite side seam. The dispensing package 10 can be used for distributing a wide variety of different particulate material including pellets, grains, powders, seeds, plant nutrient, insect dust, and chalk, and combinations thereof.

The dispensing package 10 of the present invention can be fabricated from any of a wide variety of flexible sheet materials conventionally used in the manufacture of packages including paper, coated paper, nonwoven sheet materials, films and laminates. In the embodiment shown in the drawings, the package is formed from sheets of thermoplastic polymer film. The first and second sheets 12, 14 can be formed from a single ply of film or from a multi-ply film laminate. When the first and second sheets are made from a single ply of flexible polymer film, they may be conveniently printed on either or both surfaces with printed information, indicia, logos and the like. When the front and back walls are made from a multi-ply material, printing may be applied to either or both exterior surfaces of the multi-ply material, or alternatively, one of the plies can be reverse printed with the desired information so that the printing is encapsulated within the multi-ply laminate. In this event, the exterior ply is typically transparent and the interior ply can be transparent or opaque. The single or multi-ply films can be formed from various thermoplastic polymers including polyethylene, polypropylene, polyester and nylon. When heat sealability is desired, the heat sealable surface preferably includes a sealable polymeric material such as polyethylene or ethylene copolymers.

In the embodiment shown, the side seams 26 are formed by sealing the opposing interior surfaces of the front first and second sheets 12, 14 to one another to form a simple single side seam. However, it is contemplated that when larger or more bulky materials are to be contained within the dispensing package, the sides of the package can be formed with gussets.

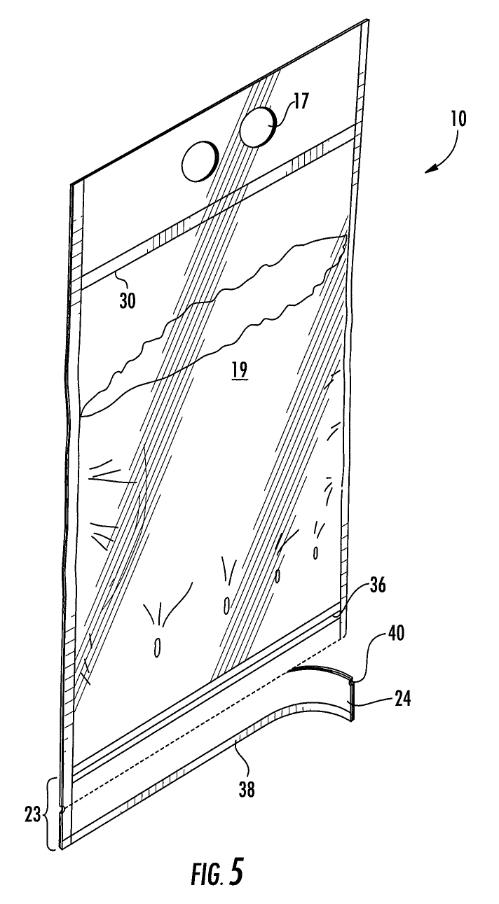

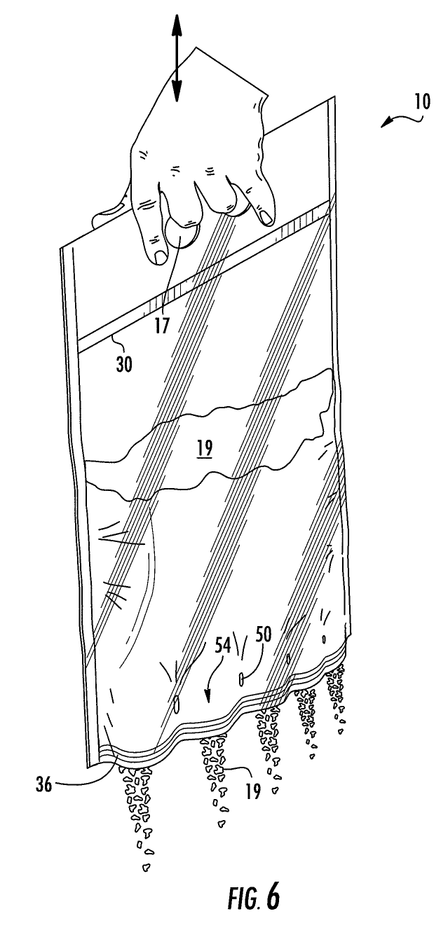

FIGS. 5 and 6 illustrate the use of a dispensing package 10 that is in accordance with the invention. FIG. 5 illustrates a filled dispensing package 10 in the process of having the bottom closure 28 of the package opened by tearing along notch 40 to remove bottom seam 38. Tearing along notch 40 can be used to remove a portion of the bottom end 24 of the dispensing package and thereby provide access to resealable closure 36. As noted above, the dispensing package may include a line of weakening that helps facilitate tearing of a bottom portion of the dispensing package.

After the bottom seam has been removed, the dispensing package may be selectively opened along resealable closure 36. Thereafter, distribution of the particulate material may be achieved by grasping the dispensing package and shaking. In this regard, FIG. 6 illustrates a user in the process of distributing particulate material from within the interior of the dispensing package. In use, the user holds the packaging dispenser by handle 17. With the bottom closure now open, a user shakes the dispensing package which causes flowable particulate material 19 (e.g., pellets, grains or powders) within package to be dispensed through the distribution channels, i.e. through the spacing between the interior seals. The flowable particulate material flows through the distribution channels and is distributed out of the now open bottom closure. A user can readily control distribution, by simply orienting the dispensing package above an object or area over which distribution of the particulate material is desired, and shaking the dispensing package 10 appropriately.

In general, the flowable particulate material may be in a variety of forms, such as, pellets, grains, seeds or powders. The maximum average dimension of the flowable particulate material is typically sufficiently smaller than the average spacing between adjacent interior seals to facilitate distribution, i.e. flow of the particulate material through the base distribution channels. As noted above, the series of interior seals can be distributed in a variety of different patterns, (e.g., linear, zig-zag, wave patterns, semi-circular, etc,) a variety of different shapes and sizes, and population density of distribution to achieve a desired flow rate of the particulate material. In general, for typical preferred embodiments, it is foreseen that a spacing of about 10 to 15 cm between adjacent interior seals may be useful for many application, such as for example distribution of grass seeds or small granular material.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A package for dispensing and distributing a flowable particulate material comprising:
first and second flexible sheets arranged in opposing face-to-face relation, each having an inner surface, a top edge, a bottom edge, and opposite side edges extending longitudinally from said top edge to said bottom edge,
side seams extending longitudinally along said opposed side edges and joining the first and second sheets to one another,
a bottom closure joining the first and second sheets to one another along a path extending transversely from one side edge to the opposite side edge to form a closed bottom for the package,
a series of interior seals joining the first and second sheets to one another in discrete areas spaced apart from one another, the interior seals being located between said top edge and said bottom closure, regions located between adjacent spaced apart interior seals defining distribution channels through which particulate material may flow, and said interior seals being configured and arranged to control the flow rate at which the particulate material may exit the package.

2. The package of claim 1, wherein said bottom closure includes a resealable closure joining the first and second sheets to one another to form a resealable opening for the package.

3. The package of claim 2, wherein said resealable closure is spaced inwardly from said bottom edge of the sheets, and including a bottom seam extending transversely along said bottom edges and joining the first and second sheets to one another.

4. The package of claim 3, further including a line of weakening formed in at least one of said sheets between said bottom seam and said resealable closure to facilitate opening the package at the bottom by tearing along the line of weakening.

5. The package of claim 3, further including a notch formed in a side edge of the sheets between said bottom seam and said resealable closure to facilitate opening the package at the bottom by tearing the first and second sheet materials.

6. The package of claim 1, wherein the first and second sheets are unsealed along the top edge to allow for filling of the package.

7. The package of claim 1, including at least one handle aperture formed in said first and second sheets in an area adjacent the top edges of the sheets.

8. The package of claim 1, wherein the first and second sheets are formed of a heat sealable polymer film, and wherein said side seams are formed by fusing the inwardly facing surfaces of the first and second sheets to one another.

9. The package of claim 1, wherein the interior seals are located closer to said bottom closure than to said top edge.

10. The package of claim 1, wherein the interior seals are spaced apart from one another along a path extending transversely from one side edge to the opposite side edge and located adjacent to said bottom closure.

11. The package of claim 10, wherein the spacing between adjacent interior seals is at least 10 times the width dimension of the seals.

12. The package of claim 10, wherein adjacent interior seals are spaced apart from one another by a distance of from 4 cm to 6 cm.

13. The package of claim 1 additionally including a quantity of a flowable particulate material of a predetermined average particle size contained within the package, and wherein the spacing between adjacent interior seals is from 2 to 5 times the average particle size of the particulate material.

14. The package of claim 13, including a top closure joining the first and second sheets to one another along a path extending transversely from one side edge to the opposite side edge to enclose the particulate material in the package between the top and bottom closures.

15. The package of claim 14, wherein the top closure is spaced inwardly from the top edges of the sheets, and including at least one handle aperture formed in the sheet material between the top closure and the top edges of the sheets.

16. The package of claim 14, wherein said flowable particulate material is selected from the group consisting of pellets, grains, powders, seeds, plant nutrient, insect dust, and chalk.

17. A package for dispensing and distributing a flowable particulate material comprising:
first and second flexible sheets arranged in opposing face-to-face relation, each having an inner surface, a top edge, a bottom edge, and opposite side edges extending longitudinally from said top edge to said bottom edge,
side seams extending longitudinally along said opposed side edges and joining the first and second sheets to one another,
a bottom closure joining the first and second sheets to one another along a path extending transversely from one side edge to the opposite side edge to form a closed bottom for the package,
a series of interior seals joining the first and second sheets to one another in discrete areas spaced apart from one another, the interior seals being located between said top edge and said bottom closure, regions located between adjacent spaced apart interior seals defining distribution channels through which particulate material may flow, and said interior seals being configured and arranged to control the flow rate at which the particulate material may exit the package, and wherein said adjacent interior seals are spaced apart from one another by a distance of from about 4 cm to 6 cm.

18. The package of claim 17, additionally including a quantity of grass seed contained within the package, the grass seed having an average particle size from about 1 mm to 2 mm, and wherein the spacing between adjacent interior seals is from 25 to 75 times the average particle size of the grass seed.

19. The package of claim 17, wherein in the interior seals extend transversely across the width of the package in a non-linear pattern.

20. The package of claim 19 wherein in the interior seals have a generally oblong shape and have a length that is aligned with the side seams of the package.

21. A package for dispensing and distributing a flowable particulate material comprising:
first and second flexible sheets arranged in opposing face-to-face relation, each having a top edge, a bottom edge, and opposite side edges extending longitudinally from said top edge to said bottom edge,
side seams extending longitudinally along said opposed side edges and joining the first and second sheets to one another,
a bottom closure joining the first and second sheets to one another along a path extending transversely from one side edge to the opposite side edge to form a closed bottom for the package, the bottom closure having a resealable closure spaced inwardly from said bottom edge of the sheets,
a bottom seam extending transversely along said bottom edges and joining the first and second sheets to one another, and
a series of interior seals joining the first and second sheets to one another in discrete areas spaced apart from one another, the interior seals being located between said top edge and said bottom closure, regions located between adjacent spaced apart interior seals defining distribution channels through which particulate material may flow, and said interior seals being configured and arranged to control the flow rate at which the particulate material may exit the package, and wherein said adjacent interior seals are spaced apart from one another by a distance of from about 1 cm to 8 cm.

22. The package of claim 21, wherein the interior seals have a diamond-like shape, a triangle-like shape, a V-like shape, or a combination thereof.

23. The package of claim 21, wherein in or more of pellets, grains, powders, seeds, plant nutrient, insect dust, or chalk are disposed in an interior space of said package.

24. The package of claim 21, wherein the spacing between adjacent interior seals is at least 15 times the width dimension of the seals.

25. The package of claim 21, wherein adjacent interior seals are spaced apart from one another by a distance of from 4 cm to 6 cm.

26. The package of claim 21 additionally including a quantity of a flowable particulate material of a predetermined average particle size contained within the package, and wherein the spacing between adjacent interior seals is from 2 to 5 times the average particle size of the particulate material.

27. The package of claim 26, including a top closure joining the first and second sheets to one another along a path extending transversely from one side edge to the opposite side edge to enclose the particulate material in the package between the top and bottom closures.
